(19) United States
(12) Patent Application Publication
(10) Pub. No.: US 2015/0378396 A1
(43) Pub. Date: Dec. 31, 2015

(54) FLEXIBLE DISPLAY APPARATUS, CONTROL METHOD THEREOF AND RECORDING MEDIUM FOR PERFORMING THE METHOD

(71) Applicant: Korea Institute of Science and Technology, Seoul (KR)

(72) Inventors: Ji Hyung PARK, Seoul (KR); Bo Kyung HUH, Seoul (KR); Gyu Hyun KWON, Seoul (KR); Hae Youn JOUNG, Seoul (KR)

(73) Assignee: KOREA INSTITUTE OF SCIENCE AND TECHNOLOGY, Seoul (KR)

(21) Appl. No.: 14/749,729

(22) Filed: Jun. 25, 2015

(30) Foreign Application Priority Data
Jun. 25, 2014 (KR) 10-2014-0078072

(51) Int. Cl. G06F 1/16; G06F 3/041

(52) U.S. Cl. CPC G06F 1/1652; G06F 3/0416; G06F 2203/04102

(57) ABSTRACT

A flexible display apparatus includes a flexible panel having a display unit for displaying a screen and a user interface for allowing a user input, a detecting unit configured to detect a handheld location on the flexible panel, and a control unit configured to change locations of the display unit and the user interface on the flexible panel according to the handheld location. Since the apparatus may be used without being hidden by the hand of a user, readability and work performance may be improved.

### CROSS-REFERENCE TO RELATED APPLICATION

This application claims priority to Korean Patent Application No. 10-2014-0078072, filed on Jun. 25, 2014, and all the benefits accruing therefrom under 35 U.S.C. §119, the contents of which in its entirety are herein incorporated by reference.

### BACKGROUND

1. Field

The present disclosure relates to a flexible display apparatus, a control method thereof and a recording medium for performing the method, and more particularly, to a flexible display apparatus for providing a user interface (UI) based on a bending technique, a control method thereof and a recording medium for performing the method.

[Description about National Research and Development Support]
This study was supported by the Future Industry-Leading Technology Development program of Ministry of Trade, Industry and Energy, Republic of Korea (Project No. 1415130097) under the superintendence of Alticast.

2. Description of the Related Art

Along with the development of electronic technologies, various kinds of display devices are being developed, and portable display devices such as TV, PC, laptop computers, tablet PC, cellular phones, MP3 plays or the like are being widely propagated. Recently, in order to cope with the demands of users who want newer and more diverse functions, many endeavors are being made to develop new-type display devices. This is a so-called next-generation display.

A flexible display apparatus is an example of the next-generation display. The flexible display apparatus is a display device whose shape can be deformed like paper, and this is a consumer-oriented future display technique by which a user may search and acquire information anytime and anywhere.

A user may deform the shape of the flexible display apparatus by applying a force, and thus the flexible display apparatus may be used for various purposes. For example, the flexible display apparatus may be implemented as a portable device such as a tablet PC, an electronic picture frame, PDA, a MP3 player or the like. Accordingly, there is needed to provide various screens and new interfaces to utilize the shape-deforming characteristics of the flexible display apparatus.

### SUMMARY

The present disclosure is directed to providing a flexible display apparatus for providing a user interface which may be conveniently used by a user.

The present disclosure is also directed to providing a control method of a flexible display apparatus so that the flexible display apparatus may be conveniently used by a user.

The present disclosure is also directed to providing a recording medium in which a computer program for performing the control method of a flexible display apparatus is recorded.

In one aspect, there is provided a flexible display apparatus, which includes: a flexible panel having a display unit for displaying a screen and a user interface for allowing a user input; a detecting unit configured to detect a handheld location on the flexible panel; and a control unit configured to change locations of the display unit and the user interface on the flexible panel according to the handheld location.

In an embodiment of the present disclosure, the control unit may display the user interface at the handheld location on the flexible panel.

In an embodiment of the present disclosure, a region on the flexible panel where the user interface is displayed may be in a bent state.

In an embodiment of the present disclosure, the control unit may move the user interface to an end of the flexible panel.

In an embodiment of the present disclosure, the control unit may move the user interface to both ends of the flexible panel.

In an embodiment of the present disclosure, the control unit may move the display unit so that the display unit does not overlap with the handheld location on the flexible panel.

In an embodiment of the present disclosure, a portion on the flexible panel where the display unit is displayed may be in a flat state.

In an embodiment of the present disclosure, the user interface may use a touch pad manner.

In an embodiment of the present disclosure, the user interface may be provided by activating a touch pad at one surface of the flexible panel.

In an embodiment of the present disclosure, the user interface may be provided by activating touch pads at both surfaces of the flexible panel.

In another aspect, there is provided a control method of a flexible display apparatus, which includes: detecting a handheld location on a flexible panel which has a display unit for displaying a screen and a user interface for allowing a user input; and changing locations of the display unit and the user interface on the flexible panel according to the handheld location.

In an embodiment of the present disclosure, the changing of locations of the display unit and the user interface may display the user interface at the handheld location on the flexible panel.

In an embodiment of the present disclosure, the changing of locations of the display unit and the user interface may move the user interface to one end of the flexible panel.

In an embodiment of the present disclosure, the changing of locations of the display unit and the user interface may move the user interface to both ends of the flexible panel.

In an embodiment of the present disclosure, the changing of locations of the display unit and the user interface may move the display unit so that the display unit does not overlap with the handheld location on the flexible panel.

In an embodiment of the present disclosure, the control method may further include, by the user interface, activating a touch pad at one surface of the flexible panel

In an embodiment of the present disclosure, the control method may further include, by the user interface, activating touch pads at both surfaces of the flexible panel

In another aspect, there is provided a computer-readable recording medium, in which a computer program for performing the control method of a flexible display apparatus is recorded.

If the flexible display apparatus and its control method are used, a location of a display unit is changed according to a handheld location in a bendable display, which gives convenience to a user. This technique is based on hardware characteristics of a flexible technique in which the display unit is bent not in a fixed pattern but in a free pattern, and thus this may guide the user to take an ergonomic pose. Moreover, since the display unit is not hidden, when performing a task using the apparatus, readability and work performance may be improved.

### BRIEF DESCRIPTION OF THE DRAWINGS

FIG. 1 is a diagram showing a flexible display apparatus according to an embodiment of the present disclosure.

FIG. 2 is a block diagram showing the flexible display apparatus of FIG. 1.

FIGS. 3 to 5 are diagrams showing locations of a display unit and a user interface.

FIGS. 6A and 6B are diagrams showing double-sided characters of the user interface.

FIG. 7A is a diagram showing a conventional art, and FIG. 7B is a diagram for illustrating the effects of the present disclosure in comparison to the conventional art.

FIG. 8 is a flowchart for illustrating a control method of a flexible display apparatus according to an embodiment of the present disclosure.

### DETAILED DESCRIPTION

The following detailed description of the present disclosure refers to the accompanying drawings which show specific embodiments implemented by the present disclosure. These embodiments are described in detail so as to be easily implemented by those skilled in the art. It should be understood that various embodiments of the present disclosure are different from each other but not exclusive from each other. For example, specific shapes, structures and features written herein can be implemented in other embodiments without departing from the scope of the present disclosure. In addition, it should be understood that locations or arrangements of individual components in each embodiment may be changed without departing from the scope of the present disclosure. Therefore, the following detailed description is not directed to limiting the present disclosure, and the scope of the present disclosure is defined just with the appended claims along and their equivalents, if it is suitably explained. In the drawings, like reference numerals denote like elements through several drawings.

Hereinafter, embodiments of the present disclosure will be described in detail with reference to the accompanying drawings.

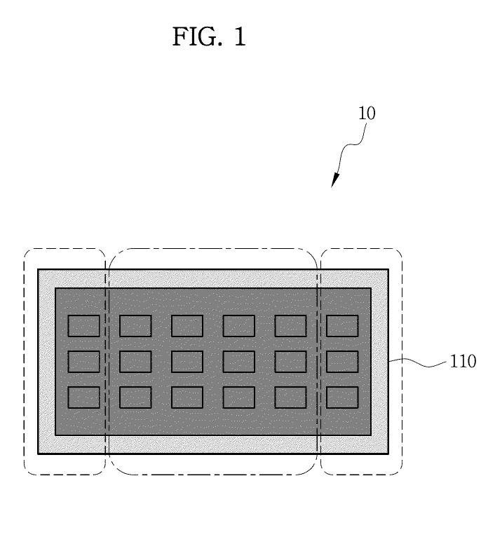

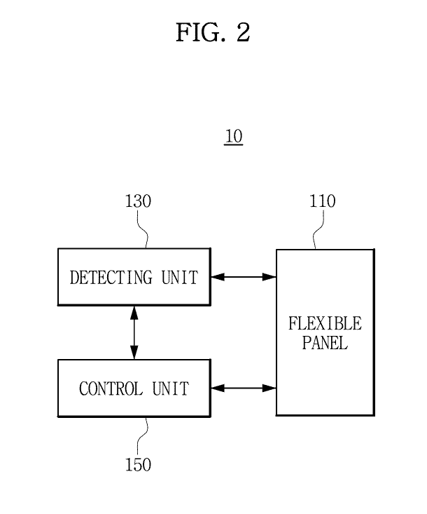

FIG. 1 is a diagram showing a flexible display apparatus according to an embodiment of the present disclosure. FIG. 2 is a block diagram showing the flexible display apparatus of FIG. 1.

Referring to FIGS. 1 and 2, a flexible display apparatus 10 (hereinafter, referred to as “the apparatus”) according to the present disclosure is a display capable of being curved or rolled without being damaged by using a thin and flexible substrate like paper, and a user may bend the apparatus partially or entirely with hardware. In addition, the apparatus 10 may be a transparent display or be utilized for using augmented reality or virtual reality.

The apparatus 10 allows wired or wireless communication and may be mobile or stationary. The apparatus 10 may also be called with other terms such as a device, an apparatus, a terminal, a UE (user equipment), a MS (mobile station), a MT (mobile terminal), a UT (user terminal), a SS (subscriber station), a wireless device, a PDA (personal digital assistant), a wireless modem, a handheld device or the like. For example, the apparatus 10 may be a terminal of a tablet size to which a bending technique is applied to allow free bending, instead of fixed deformation.

The apparatus 10 detects a handheld location of a user by using a bending characteristic and provides a user interface environment which is convenient to the user. For this, the apparatus 10 includes a flexible panel 110, a detecting unit 130 and a control unit 150.

The flexible panel 110 includes a display unit for displaying a screen and a user interface for allowing a user input. The user interface may use a touch pad manner and, the user interface may be displayed on the flexible panel 110.

The flexible panel 110 may be implemented with a plastic substrate (for example, a polymer film) which may be deformed by an external pressure. The plastic substrate is configured so that barrier coatings are formed on both surfaces of a base film. The base film may be made of various resins such as PI (Polyimide), PC (Polycarbonite), PET (Polyethyleneterephtalate), PES (Polyethersulfone), PEN (Polythylenenaphthalate), FRP (Fiber Reinforced Plastic) or the like. In addition, the barrier coatings are formed on facing surfaces of the base film and may be made of an organic film or an inorganic film to maintain flexibility.

Meanwhile, the flexible panel 110 may be made of flexible material such as a thin glass or a metal foil, in addition to the plastic substrate. In other case, the flexible panel 110 may be implemented with an organic light emitting diode, EL, EPD (electrophoretic display), ECD (electrochromic display), LCD (liquid crystal display), AMLCD, PDP (Plasma display Panel) or the like.

The flexible panel 110 may deform its shape by being bent due to an external pressure. Bending may include normal bending, folding and rolling. Normal bending means that the flexible display apparatus is bent, and the bent surfaces do not contact each other, different from folding and rolling. Folding means that the flexible display apparatus is folded. Folding and normal bending may be classified depending on the degree of bending. For example, if bending is made over a predetermined curvature radius, the bending may be defined as folding. Also, if bending is made smaller than a predetermined curvature radius, the bending may be defined as normal bending.

Rolling means that the flexible display apparatus is rolled. Rolling may also be determined based on a curvature radius. For example, if bending over a predetermined curvature radius is detected over a predetermined region, this state may be defined as rolling. Also, if bending over a predetermined curvature radius is detected within a relatively small region, this state may be defined as folding.

However, the above definitions on various bending states are just an example, and the bending states may also be defined differently depending on the kind, size, weight, characteristics of the like of the flexible display apparatus. For example, if the flexible display apparatus 10 is able to be bent so that its surfaces come into contact with each other, folding and bending may be simultaneously defined as a state where surfaces of the apparatus contact each other. Meanwhile, rolling may be defined as a state where front and rear surfaces of the flexible display apparatus come into contact with each other by bending.

For convenience, in this specification, various bending states as described above and other bending states will be generally called bending.

The detecting unit 130 detects a handheld location on the flexible panel 110.

The detecting unit 130 may include a bend sensor disposed at a front or rear surface of the flexible panel 110 or bend sensors disposed at the front and rear surfaces thereof. Here, the bend sensor means a sensor which is able to be bent in itself and whose resistance varies depending on the degree of bending. The bend sensor may be implemented with a strain gauge. The strain gauge detects deformation of a surface of a measurement target by using a metal or semiconductor whose resistance greatly varies according to the intensity of force applied thereto. Generally, in case of a material such as metal, if its length increases due to the force applied from the outside, its resistance increases, and if its length decreases, its resistance decreases. Therefore, bending may be determined by detecting the change of resistance.

The detecting unit 130 may detect resistance of the bend sensor by using the intensity of a voltage applied to the bend sensor or the intensity of a current flowing through the bend sensor and detect a bending state at a corresponding location of the bend sensor according to the intensity of resistance.

However, the detecting unit 130 may also detect a handheld location in various ways, without being limited to the above.

The control unit 150 changes locations of the display unit and the user interface on the flexible panel 110 according to the handheld location. In detail, the control unit 150 may check a handheld location of the user by using a value sensed by a sensor of the detecting unit 130, move the display unit not to overlap with the handheld location, and move the user interface to overlap with the handheld location.

The user may grip the flexible panel 110 by the hand in order to use the apparatus 10. At this time, since the flexible panel 110 is fixed using a right hand, a left hand or both hands, the user generally holds one end or both ends of the flexible panel 110 in a horizontal direction.

In this case, the user may bend a portion of the flexible panel 110 which is held by the hand, by means of flexibility which is hardware characteristic. In addition, as the user holds the flexible panel 110, the flexible panel 110 may be bent in itself due to its flexibility.

Therefore, the handheld location may coincide with a bent portion of the flexible panel 110, and the user interface may be displayed at the handheld location, namely in the bent portion of the flexible panel 110. Meanwhile, the display unit may display an image out of the handheld location.

In other words, in the present disclosure, the user interface may be a bent portion which may be easily held by the user, and the display unit may be a flat portion which displays a screen without any distortion.

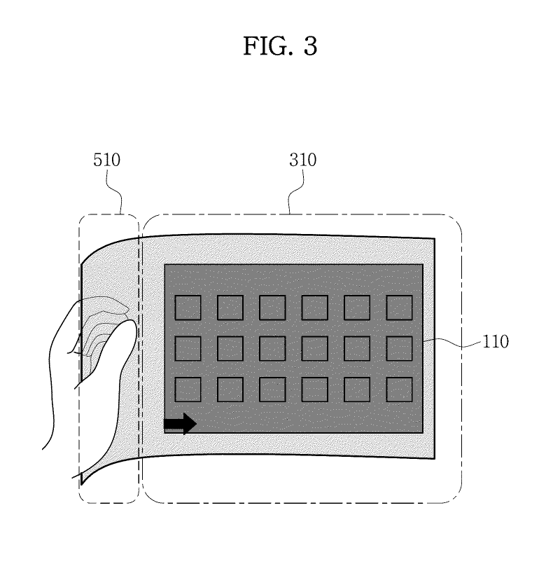

Referring to FIGS. 3 to 5, locations of the display unit and the user interface are depicted as examples.

Referring to FIG. 3, a left end of the flexible panel 110 is held. Here, the user interface 510 is moved to the left end of the flexible panel 110, and the display unit 310 is displayed at a right side.

Accordingly, the screen displayed on the display unit 310 is not hidden by the hand, and thus the user may efficiently perform a task on the flexible panel 110. In addition, since the user interface 510 is provided near the hand of the user, the user may use the user interface 510 conveniently. Moreover, since the flexible panel 110 displaying the user interface 510 is bent, there is no burden applied to the wrist of the user.

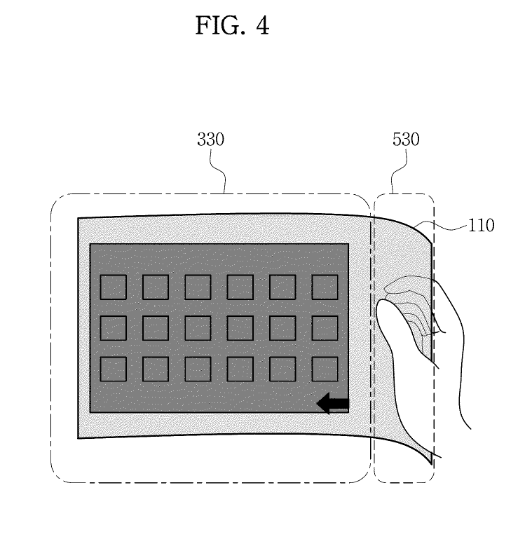

Referring to FIG. 4, a right end of the flexible panel 110 is held. In this case, the user interface 530 is moved to the right end of the flexible panel 110, and the display unit 330 is displayed at a left side.

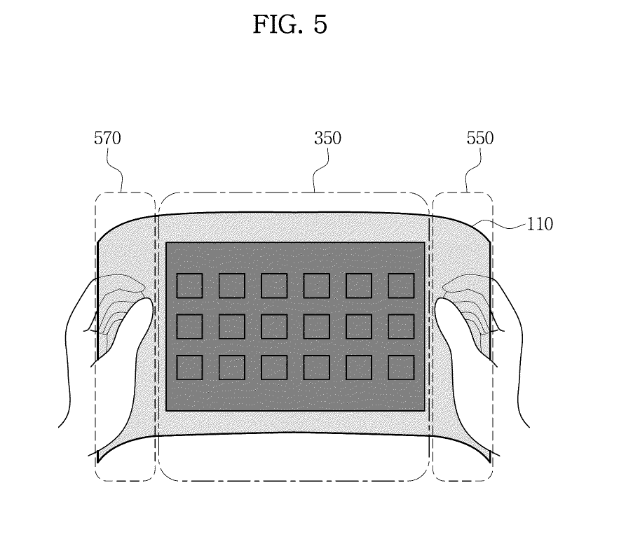

Referring to FIG. 5, both ends of the flexible panel 110 are held. Here, the user interfaces 550, 570 may be displayed at both ends of the flexible panel 110, and the display unit 350 is displayed at the center.

The user interface may use a touch pad manner in which gestures of the user such as clicking, scrolling, double-tapping or the like are implemented, and a virtual keyboard, keypad or the like allowing a touch input of the user may be provided on the flexible panel 110. The user interface may provide a touch pad on one surface (a front surface or a rear surface) of the flexible panel 110 or touch pads on both surfaces (the front and rear surfaces) thereof.

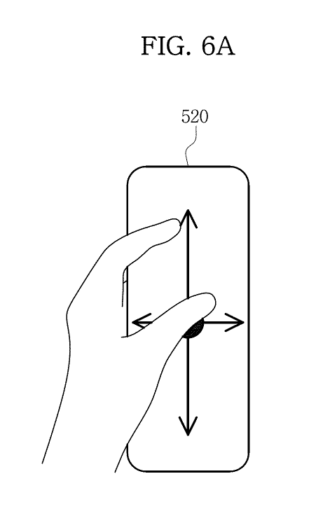

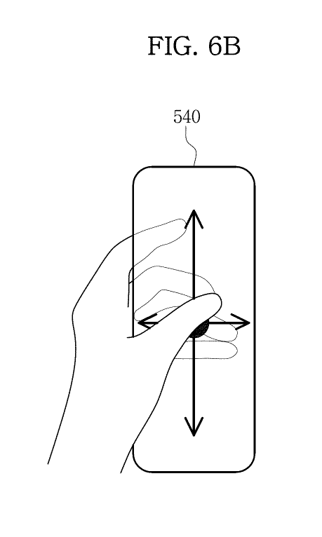

Referring to FIG. 6A, the user interface 520 is in a state where a touch pad at the front surface of the flexible panel 110 is activated. However, different from the above, a touch pad at the rear surface of the flexible panel 110 may also be activated.

Referring to FIG. 6B, the user interface 540 is in a state where touch pads at both surfaces of the flexible panel 110 are activated. In this case, the apparatus 10 may be a transparent display device, and the user may select whether to activate only a touch pad at one surface or touch pads at both surfaces.

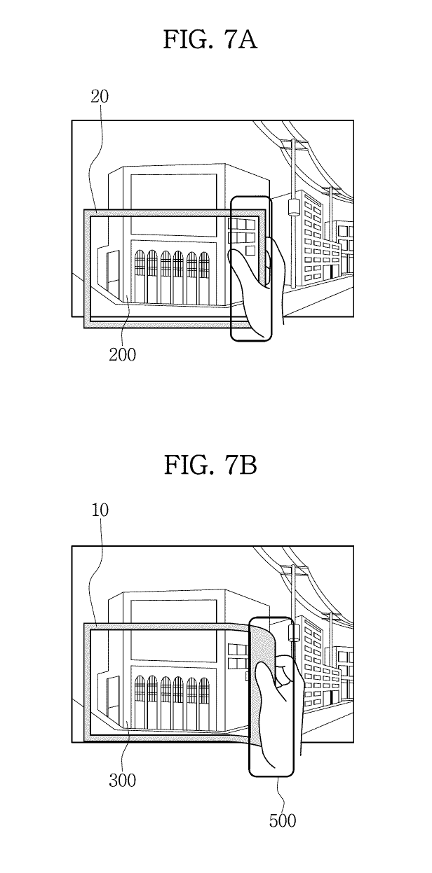

FIG. 7A shows a conventional flexible display apparatus 20, in which a user interface and an image 200 are displayed regardless of a handheld location of a user. Therefore, the image may be hidden by the hand of the user, which disturbs the user from working.

However, in the flexible display apparatus 10 according to the present disclosure, as shown in FIG. 7B, a handheld location of the user is detected, and then locations of the user interface 500 and the display unit 300 are automatically adjusted. Therefore, a screen displayed on the display unit 300 is not hidden, which improves readability and work performance. In addition, since the user holds a bent portion of the apparatus, the user may maintain an ergonomic pose, which may minimize a load applied to the wrist of the user. The present disclosure provides a new UI (User interface) based on UX (User experience) based on the hardware characteristics of the apparatus.

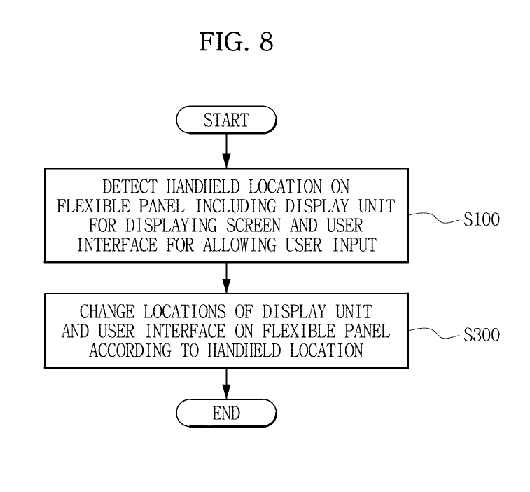

FIG. 8 is a flowchart for illustrating a control method of a flexible display apparatus according to an embodiment of the present disclosure.

The control method of a flexible display apparatus according to this embodiment may be executed using substantially the same configuration of the apparatus 10 depicted in FIG. 2. Therefore, an element substantially identical to that of the apparatus 10 is designated with the same reference symbol and is not described in detail here.

In other case, the control method of a flexible display apparatus according to this embodiment may be executed by means of software (an application) for controlling the flexible display apparatus.

Referring to FIG. 8, the control method of a flexible display apparatus according to this embodiment detects a handheld location on a flexible panel, which includes a display unit for displaying a screen and a user interface for allowing a user input (S100).

The handheld location may be detected by a bend sensor included in the flexible panel.

Subsequently, locations of the display unit and the user interface on the flexible panel are changed according to the handheld location (S300).

The handheld location may coincide with a bent portion of the flexible panel, and the user interface may be displayed at the handheld location, namely in the bent portion of the flexible panel. Meanwhile, the display unit may display an image out of the handheld location.

In the present disclosure, the user interface may be a bent portion which may be easily held by the user, and the display unit may be a flat portion which displays a screen without any distortion.

For example, the user interface may be displayed at one end or both ends of the flexible panel. In addition, the user interface may activate touch pads at both surfaces of the flexible panel or a touch pad at one surface thereof.

The control method of a flexible display apparatus as described above may be implemented as an application or program commands executable by various kinds of computer means and recorded on a computer-readable recording medium. The computer-readable recording medium may include program commands, data files, data structures or the like solely or in combination.

The program commands recorded on the medium may be specially designed or configured for the present disclosure or known to and available by computer software engineers.

The computer-readable recording medium includes, for example, magnetic media such as a hard disk, a floppy disk and a magnetic tape, optical media such as CD-ROM and DVD, magneto-optical media such as a floptical disk, hardware devices such as ROM, RAM and a flash memory, specially configured to store and perform program commands, or the like.

The program commands include not only machine codes made by a complier but also high-level language codes executable by a computer by using an interpreter. The hardware device may be configured to operate as at least one software module to perform the operations of the present disclosure, or vice versa.

While the exemplary embodiments have been shown and described, it will be understood by those skilled in the art that various changes in form and details may be made thereto without departing from the spirit and scope of this disclosure as defined by the appended claims.

In new and alternate markets of displays, flexible displays are being developed more and more, and it is predicted that this trend will be accelerated further. The developed flexible displays have increasing sizes, from a mobile size, and they are also predicted as being more greatly bent, like paper. The present disclosure is a user interface employing transparency, deformation and double-sided character of flexible displays and may improve institutive cognitive performance. Therefore, the present disclosure may be widely utilized in the flexible display market which is gradually increasing.

What is claimed is:

1. A flexible display apparatus, comprising:
a flexible panel having a display unit for displaying a screen and a user interface for allowing a user input;
a detecting unit configured to detect a handheld location on the flexible panel; and
a control unit configured to change locations of the display unit and the user interface on the flexible panel according to the handheld location.

2. The flexible display apparatus according to claim 1,
wherein the control unit displays the user interface at the handheld location on the flexible panel.

3. The flexible display apparatus according to claim 2,
wherein a region on the flexible panel where the user interface is displayed is in a bent state.

4. The flexible display apparatus according to claim 1,
wherein the control unit moves the user interface to an end of the flexible panel.

5. The flexible display apparatus according to claim 1,
wherein the control unit moves the user interface to both ends of the flexible panel.

6. The flexible display apparatus according to claim 1,
wherein the control unit moves the display unit so that the display unit does not overlap with the handheld location on the flexible panel.

7. The flexible display apparatus according to claim 6,
wherein a portion on the flexible panel where the display unit is displayed is in a flat state.

8. The flexible display apparatus according to claim 1,
wherein the user interface uses a touch pad manner.

9. The flexible display apparatus according to claim 8,
wherein the user interface is provided by activating a touch pad at one surface of the flexible panel.

10. The flexible display apparatus according to claim 8,
wherein the user interface is provided by activating touch pads at both surfaces of the flexible panel.

11. A control method of a flexible display apparatus, comprising:
detecting a handheld location on a flexible panel which has a display unit for displaying a screen and a user interface for allowing a user input; and
changing locations of the display unit and the user interface on the flexible panel according to the handheld location.

12. The control method of a flexible display apparatus according to claim 11,
wherein the changing of locations of the display unit and the user interface displays the user interface at the handheld location on the flexible panel.

13. The control method of a flexible display apparatus according to claim 11,
wherein the changing of locations of the display unit and the user interface moves the user interface to one end of the flexible panel.

14. The control method of a flexible display apparatus according to claim 11,
wherein the changing of locations of the display unit and the user interface moves the user interface to both ends of the flexible panel.

15. The control method of a flexible display apparatus according to claim 11,
wherein the changing of locations of the display unit and the user interface moves the display unit so that the display unit does not overlap with the handheld location on the flexible panel.

16. The control method of a flexible display apparatus according to claim 11, further comprising:
by the user interface, activating a touch pad at one surface of the flexible panel.

17. The control method of a flexible display apparatus according to claim 11, further comprising:
by the user interface, activating touch pads at both surfaces of the flexible panel.

18. A computer-readable recording medium, in which a computer program for performing the control method of a flexible display apparatus according to claim 11 is recorded.
